(19) United States
(12) Patent Application Publication
(10) Pub. No.: US 2007/0081934 A1
(43) Pub. Date: Apr. 12, 2007

(54) METHOD FOR IMPROVING THE EFFICIENCY OF REDUCING NOX IN MOTOR VEHICLES

(75) Inventors: Stefan Hubig, Urexweiler (DE); Ronny Monnig, Wiesbaden (DE); Helmut Oswald, Albig (DE); Peter Zima, Mainz (DE)

Correspondence Address: INGRASSIA FISHER & LORENZ, P.C., 7150 E. CAMELBACK, STE. 325, SCOTTSDALE, AZ, 85251, US

(73) Assignees: GM Global Technology, Inc., Detroit, MI (US); Fiat Auto S.p.A., Torino (IT)

(21) Appl. No.: 11/532,266

(22) Filed: Sep. 15, 2006

Related U.S. Application Data
(63) Continuation of application No. PCT/EP05/02655, filed on Mar. 12, 2005.

(30) Foreign Application Priority Data
Mar. 17, 2004 (DE) 10 2004 013165.1

(51) Int. Cl. B01D 53/86

(52) U.S. Cl. 423/239.1; 423/239.2

(57) ABSTRACT

The invention relates to a method for reducing NOₓ in exhaust gas flows of a motor vehicle, by means of a catalyst. The method is characterized in that an NOₓ absorbing material is provided in the catalyst.

### CROSS-REFERENCE TO RELATED APPLICATIONS

This is a continuation of International Application No. PCT/EP2005/002655, filed Mar. 12, 2005, which application claims priority to German Application No. 10 2004 013165.1, filed Mar. 17, 2004, which are hereby incorporated by reference in their entirety.

### FIELD OF THE INVENTION

The invention relates to a method for improving the efficacy of NOₓ, reduction in motor vehicles.

### BACKGROUND OF THE INVENTION

Legislation has already provided for a drastic reduction in the limit values for pollutants in the Guideline EU IV for the future.

The so-called selective catalytic reduction process (SCR process) is known for reduction of the NOₓ, content in the exhaust gas of an internal combustion engine operated with excess air. In this process, at a location upstream of a catalyst a selectively acting reducing agent is fed to the exhaust gas, mostly through injection, and through this reducing agent the NOₓ, contained in the exhaust gas can be converted in a chemical reaction to eco-neutral components (N₂, O₂, H₂O) in the SCR catalyst. The known process is already applied today in diesel engines in the heavy-duty (truck) field, wherein frequently aqueous urea solutions (32.5% by mass; known under the name ‘AdBlue’) or solid urea in pelleted or powdered form are used. Reducing agents that exhibit a particularly active effect are those, from which ammonia can be released as an intermediary, e.g. urea, a urea-water solution, solid ammonium carbamate or gaseous ammonia. The said reducing agents can reduce nitrogen oxides by means of (vanadium oxide-containing) catalysts to more than 95% even with a non-stoichiometric dosage. With ammonia (NH₃) as reducing agent, this process has been successfully used for decades in power stations for the reduction of nitrogen oxide.

Solid or liquid materials are better suited for mobile use, these being hanuless and eco-neutral, in contrast to toxic ammonia, while allowing the ammonia necessary for the catalytic reaction to be generated onboard a motor vehicle. An example of such a substance is urea, from which ammonia can be extracted through thermal decomposition, or preferably through hydrolytic processes. There is the problem that irrespective of the catalyst and reducing agent, the exhaust temperatures, e.g. in the cold start phase of the engine or during urban travel with frequent idling phases, are possibly not sufficient for the selective catalytic reduction. In particular, the precisely targeted addition (dosage) of the reducing agent then constitutes a complicated problem with respect to control that cannot always be resolved satisfactorily. There is the risk of a leakage of ammonia (breakthrough of free NH₃ through the catalyst), which must be absolutely avoided because of the toxicity of ammonia.

For this reason, the direct use, also without processing, of fuel as reducing agent appears promising. In diesel engines, for example, additional diesel fuel can be injected directly into the exhaust cycle of the engine by means of a conventional injection system, or an additional injection valve, through which the diesel fuel or another suitable hydrocarbon is injected, can be provided before the existing SCR. catalyst. In the case of Otto-cycle internal combustion engines the exhaust gas itself generally contains a sufficient HC quantity for the NOₓ, reduction.

The catalysts known from the prior art (e.g. 3-way technology for petrol and/or CNG-operated aggregates) use porous ceramic or noble metal substrates with particularly large surface areas, to which catalytically active noble metals such as platinum or rhodium are applied within a washcoat coating. However, these catalysts are complicated to produce and are, moreover, therefore frequently very costly. Moreover, it has been found that contamination of the enviroment occurs over time from heavy metal that has leached out of the catalyst. In addition, the motor vehicle catalysts used today are frequently extremely sensitive to sulphur and/or sulphates, which for these catalysts constitute catalyst poisons, as a result of which the catalyst is at least partially deactivated.

A further problem of the catalyst technology known from the prior art is that for an optimum effect of the catalyst a certain threshold of NOₓ, must be exceeded in the exhaust gas, but this is not the case in all operating states of the engine. If the combination of all these influences is considered, then only an inadequate NOₓ reduction occurs in some circumstances.

### BRIEF SUMMARY OF THE INVENTION

It is an object of the present invention to provide a method, with which a reliable, highly effective and quick NOₓ reduction is achieved in motor vehicles.

A method according to the invention for reducing NOₓ, in the exhaust gas flow of a motor vehicle by means of a catalyst or adsorbent is characterized in that a NOₓ-absorbing (or temporarily binding) material is present in the catalyst. Methods for reducing NOₓ, by means of a catalyst known hitherto are characterized by only the reaction partner of the NOₓ, whether NH₃, urea or hydrocarbons, being bound, whereupon a reaction of the bound reaction partner, which is possibly also changed into a more reactive intermediate substance, occurs with the NOₓ, of the gas phase, but this only forms a direct bond with the catalyst with great difficulty. However, if the NOₓ is adsorbed on the surface of the material according to the invention, then a local enrichment of the NOₓ can therefore firstly occur, which enables its subsequent reduction to then be conducted with greater efficiency.

Absorbing in the sense of the present invention means in particular that the NOₓ-absorbing material preferably does not catalyse the reduction of the nitrogen oxides at lower temperatures, e.g. directly after a cold start of the engine. However, this material can also have a NOₓ-reducing property or function at increasing temperatures.

A preferred embodiment of the method according to the invention is characterized in that a NOₓ-absorbing material is present in the catalyst in addition to a NOₓ-reducing material in the catalyst. It should be noted that this can also be achieved by using a material as described above, which is primarily only absorbent at low temperatures and at the same time still has a reducing effect at higher temperatures. However, at least two different materials can also be used, wherein one set of materials has a primarily absorbing effect, the other materials have a primarily reducing effect, however these can supplement one another in any conceivable manner.

Therefore, the method according to the invention enables a sufficient reduction of NOₓ to be achieved in all operating conditions of a lean-burn internal combustion engine. This is achieved firstly in that NOₓ is trapped and enriched by the NOₓ-absorbing material, as a result of which the effective, local concentration is increased. If the desorption temperature for the material is then clearly exceeded, then the reduction can occur in an even more efficient manner with an increased concentration of NOₓ. This can occur either with the same material or with a material provided specifically for this.

In a preferred embodiment of the invention, the NOₓ-absorbing and/or NOₓ-reducing material is already NOₓ-absorbent at temperatures of ≦500° C., preferably ≦400° C., more preferred ≦300° C., further preferred <200° C., and also most preferred ≦150° C. and also ≧20° C. In this case, at low exhaust gas temperatures, e.g. on startup of the engine (start-up of the motor vehicle, in particular in wintry conditions), an absorption of the NOₓ occurs (but not via nitrates such as have to firstly be formed by a commercial NOₓ trap prior to storage thereof). NO, and NO₂ to a lesser extent (this being scarcely formed at all in engines), is preferably temporarily bound by the material and thus enriched.

A preferred embodiment of the method according to the invention is characterized in that the NOₓ-absorbing material is selected from a group comprising natural, synthetic, ion-exchanging, non-ion-exchanging, modified, non-modified, “pillared”, non-“pillared” clay materials, sepiolites, attapulgites, natural, synthetic, ion-exchanging, non-ion-exchanging, modified, non-modified zeolites, Cu, Ba, K, Sr and Ag-laden, Al, Si and Ti-“pillared” montmorillonites, hectorites doped with Fe, In, Mn, L,a, Ce or Cu as well as mixtures thereof, Cu, Fe, Ag, Ce-laden clinoptilolites as well as mixtures thereof.

embodiment of the method according to the invention is characterized in that the NOₓ-reducing material is selected from a group comprising natural, synthetic, ion-exchanging, non-ion-exchanging, modified, non-modified, “pillared”, non-“pillared” clay materials, sepiolites, attapulgites, natural, synthetic, ion-exchanging, non-ion-exchanging, modified, non-modified zeolites, Cu, Ba, K, Sr or Ag-laden, as well as Al, Si- or Ti-“pillared” montmorillonites, hectorites doped with Fe, In, Mn, L,a, Ce or Cu as well as mixtures thereof, Cu, Fe, Ce, Ag-laden clinoptilolites as well as mixtures thereof.

A preferred catalyst or a preferred absorbent in the framework of the present invention is characterized in that it is composed on the basis of clay minerals and synthetic or naturally occurring zeolites. In the sense of the present invention, on the basis of clay mineral means in particular that the catalyst is composed of clay minerals to ≧30% (% by wt.), preferably to ≧60% (% by wt.) and also most preferred to ≧80% (% by wt.). For this, the hydrocarbons available in the motor vehicle (directly or firstly “reformed”) and/or CO and/or H₂ are used as actual reducing agent.

A preferred embodiment of a catalyst according to the present invention is characterized in that it additionally contains zeolites (in the same phase, in the form of mixed crystallisate or also of mechanical mix). In this case, the content of zeolites is preferably ≧10% (% by wt.), more preferred 24 20% (% by wt.), and also most preferred ≧30% (% by wt.).

A preferred embodiment of a catalyst according to the present invention is characterized in that it contains oxidative and reductive regions, which, depending on the embodiment, were formed both on one and the same or on different minerals (clay mineral, zeolite). A particularly efficient reduction of NO can always occur when firstly a portion of the NO is oxidized to NO₂ and also another portion of NO is reduced to NH₃ by means of the hydrocarbons. A recombination of several substances adsorbed on the catalyst then occurs to form N₂ and water.

Therefore, when there are regions that have an oxidative effect and those that have a reductive effect together with the hydrocarbons present within the catalyst, the efficiency of the NOₓ reduction can be substantially increased in a proven manner.

Clay minerals should be understood to mean phyllosilicates in particular, but also sheet silicates [e.g. palygorskite (attapulgite) and sepiolite (meerschaum)]. A preferred embodiment of a catalyst according to the present invention is characterized in that the clay mineral is selected from the group comprising kaolinite, ilerite, kanemite, magadiite, smectites, montinorillonite, bentonite, hectorite, palygorskite and sepiolite as well as mixtures thereof. Bentonite, sepiolite, hectorite and also moutmorillonite are particularly preferred.

A preferred embodiment of a catalyst according to the present invention is characterized in that the clay mineral of the catalyst contains in particular basic-acting cations preferably selected from the group comprising Ba, Na, Sr, Ca and Mg as well as mixtures thereof. In particular it is known of Ba²⁺ions that together with suitable clay minerals these can bind hydrocarbons and convert them into more reactive substances such as aldehydes, which then allow the NOₓ reduction.

A preferred embodiment of a catalyst according to the present invention is characterized in that the catalyst carries oxidative-acting metal ions preferably selected from the group comprising Ag, Ce, Fe, Cu, La, Pr, Th, Nd, In, Cr, Mn, Co and Ni as well as mixtures thereof. Thus, an oxidation of NO to NO₂ can be effected according to the mechanism outlined above.

A preferred embodiment of a catalyst according to the present invention is characterized in that the catalyst is composed on the basis of modified bentonite. Further particularly preferred catalysts are characterized in that they contain modified clay minerals selected from the group comprising bentonites, smectites, hectorites, as well as mixtures thereof, pillared with aluminium, silicon or titanium (oxides).

A further embodiment of the catalyst particularly preferred in the framework of this invention contains at least one oxidative region, which contains zeolites, for example, and a reductive region, which can be formed by clay minerals. In view of the known form selectivity of the zeolites, these are particularly suitable for only oxidising the NO, while because of their size, the hydrocarbons can reach the reactive centres of the zeolites in a substantially more delayed maimer and are therefore practically not oxidized. However, because of their substantially two-dimensional pore systems, clay minerals are particularly suitable for the absorption of suitable hydrocarbons.

A preferred embodiment of a catalyst according to the present invention is characterized in that the catalyst contains a zeolite selected from the group comprising naturally occurring, ion-exchanged and/or synthesized zeolite A, zeolite X, zeolite Y, heulandite, clinoptilolite, chabasite, erionite, mordenite, ferrierite, MFI (ZSM-5), zeolite-beta faujasite, mordenite or mixtures thereof.

Moreover, zeolites that are usable in the framework of the present invention can be selected from the group comprising zeolite A, zeolite X,Y and/or heu(landites. The use of clinoptilolite, chabasite, erionite, mordenite, ferrierite, MFI (ZSM-5) and also zeolite-beta is preferred. The latter zeolite structures are characterized by a lower Al content, which while it reduces the ion exchange capacity, has the advantage of high temperature stability (up to 550° C. continuous operation).

Faujasites, heulandites and mordenites are to be specified as particularly suitable zeolites. Together with zeolites X and Y, the mineral faujasite belongs to the faujasite types within zeolite structure group 4, which are characterized by the double six-membered ring subunit D6R (cf. Donald W. Breck: “Zeolite Molecular Sieves”, John Wiley & Sons, New York, London, Sydney, Toronto, 1974, page 92). The naturally occurring minerals cliabazite and gmelinite as well as further synthetically obtainable zeolites also belong to zeolite structure group 4 besides the specified faujasite types.

In particular, heulandites have the general formula (Na, K)Ca₄[Al₉Si₂₇O_{72].} 24H₂O or Ca₄[Al₈Si₂₈O_{72].} 24H₂O). Together with the SiO₂ richer clinoptilolite, they are monoclinic in the crystal class 2/m-C2h and form foliated to tabular crystals, often grown singly or in subparallel aggregates, also shelly, scaly or sparry aggregates with perfect cleavage with pearl-like lustre on the cleavage faces (see also Gottardi-Galli, Natural Zeolites, pp. 256-284).

Mordenites have the general structure Na₃KCa₂[Al₈Si₄₀O_{96].}28H₂O. Structural units of the crystalline structure are five-membered rings of tetrahedrons, which form superposed chains. Through the joint corners of two tetrahedrons of five-membered rings, four-membered rings are also formed; four- or five-membered rings jointly enclose twelve-membered rings: see illustration. Mordenite forms tiny prismatic, needle-like or fine-fibred white to colourless crystals, often in the form of cotton-like aggregates, and sturdy vitreous masses (see also Gottardi-Galli, Natural Zeolites, pp. 223-233, Berlin-Heidelberg: Springer 1985).

Zeolites of the faujasite type are structured from β-cages, which are linked tetrahedrally via D6R subunits, wherein the β-cages are arranged in a similar maiiner to the carbon atoms in diamond. The three-dimensional network of the zeolites of the faujasite type suitable according to the invention has pores of 2.2 and 7.4 Å, and moreover the unit cell contains 8 cavities (super-cages) with a diameter of approximately 13 Å and can be represented by the formula Na₈₆[(AlO₂)₈₆(SiO₂)₁₀₆].n H₂O (n is preferably 264). (All data from: Donald W. Breck: “Zeolite Molecular Sieves”, John Wiley & Sons, New York, London, Sydney, Toronto, 1974, pages 145, 176, 177).

Mixes, mixed crystals and/or co-crystallisates of zeolites of the faujasite type (also in the form of mechanical mixes) are also suitable according to the invention besides other zeolite structures, which do not necessarily have to belong to zeolite structure 4 (according to the Breck classification), wherein preferably at least 70% by wt. of zeolites of the faujasite type, mordenites and/or heulandites are contained.

The zeolites used in the framework of this invention preferably have pore sizes of 2.8-8.0 Å. In general, it applies that in some instances the said pore radius varies considerably with the Al content of the zeolites and the type and quantity of the co-cations for the charge equalisation (alkali metals, alkaline earth metals, subgroup elements).

A preferred embodiment of a catalyst according to the present invention is characterized in that the percentage content by weight of copper and/or iron in the catalyst, measured on the basis of the weight of the entire catalyst, lies between ≧0% by wt. and ≦25% by wt., preferably between ≧0.01% by wt. and ≦20% by wt., more preferred between ≧0.05% by wt. and ≦15% by wt., and also most preferred between ≧0.1% by wt. and ≦10% by wt. Because of their catalytic activity, iron and copper have a further efficiency-enhancing effect. Further suitable metals are, inter alia, silver, cerium, manganese, indium and/or platinum, wherein the latter is less preferred.

With the exception of copper, iron and also possibly titanium, the catalyst is heavy metal-free, wherein heavy metal-free in the sense of the present invention means that the catalyst contains less than ≦1% by wt., preferably less than ≦0.8% by wt., more preferred less than ≦0.6% by wt., more preferred less than ≦0.4% by wt., and also most preferred less than ≦0.1% by wt. of heavy metals. In the sense of the present invention, heavy metals are understood in particular to be the platinum group elements.

A preferred embodiment of a catalyst according to the present invention is characterized in that the catalyst additionally also carries metal oxides, wherein the metal of the metal oxide is not a heavy metal with the exception of possibly copper, iron, indium, molybdenum or titanium.

It is particularly preferred that the catalyst also contains aluminium oxide. As a result of the pillar process, this has a substantial surface-increasing effect, wherein the interlayer spacing of the minerals can be permanently widened through nano-oxides formed, which in turn allows the generation of a permanent pore system within the catalyst. Reference is made to N. D. Hudson et al., Microporous and Mesoporous Materials, 1999, pp. 447-459 in this regard. A further preferred oxide is titanium oxide or silicon oxide, which can likewise be used to increase the surface and construct the “pillared clays”.

A preferred embodiment of a catalyst according to the present invention is characterized in that the content of metal oxide in mmol per g of catalyst amounts to ≦100 mmol of metal/g, more preferred ≦50 mmol of metal/g, further ≦20 mmol of metal/g, ≦10 mmol of metal, and also most preferred from ≦6 mmol of metal/g to ≧0 mmol of metal/g, preferably ≦1 mmol of metal/g.

In a preferred embodiment of the catalyst, copper can be used as an additional catalytically active component. Copper presumably takes on the decisive role of an active centre in the complex catalytic process of NOₓ reduction. This role can evidently also be assumed by iron, manganese, indium, molybdenum and to a certain degree also titanium, which are therefore likewise preferred in the framework of the present invention. It is assumed that as promoters these co-cations farther improve the efficiency of the copper.

As mentioned above, copper-laden zeolites (such as Cu/ZSM-5) are already known principally as active catalyst in the de-NOₓ process, however sufficiently stable forms for real exhaust gas conditions (up to 800° C., to 20% by vol. of water, sulphur compounds) have not as yet been successfully produced. The decisive co-cation stabilising function is possibly attributed to the clay minerals. Particularly suitable for this are modified clay minerals (ion-exchanged pillared clays: so-called PILCs) or naturally occurring zeolites such as clinoptilolite and/or mordenite.

The percentage content by weight of (elemental) copper in the catalyst, measured on the basis of the weight of the entire catalyst, preferably lies between ≧0.01% and ≦25%, preferably between ≧0.1% and ≦20%, more preferred between ≧1% and ≦15%, and also most preferred between ≧2% and ≦10%. These data also apply to the active metal or iron acting as co-cation, wherein mixtures of both metals have also been positively tested. Improvements in activity could be achieved through Ti and/or Ag, Ce additions and/or La additions and/or Ca, Co, Ni, In, Cr and Mn as trace quantity additions, which therefore likewise constitute preferred additions. In the case of clay minerals, ion-exchanged samples pillared with Al, Si and/or with Ti and/or Cu, Fe are particularly effective and preferred on this basis.

A preferred embodiment of a catalyst according to the present invention is characterized in that the microporous average pore size lies between ≧0 nm and ≦2 nm, preferably between ≧0.1 nm and ≦1.0 nm, more preferred between ≧0.2 nm and ≦0.8 nm, and also most preferred between ≧0.21 nm and ≦0,6 mn.

A preferred embodiment of a catalyst according to the present invention is characterized in that the mesoporous average pore size lies between ≧0 nm and ≦10 nm, preferably between ≧1 nm and ≦9 nm, more preferred between ≧2 nm and ≦8 nm, and also most preferred between ≧2.5 nm and ≦7 nm.

A preferred embodiment of a catalyst according to the present invention is characterized in that the surface (measured according to the BET method or in the multipoint process) of the clay mineral and/or zeolite, which forms the basis of the catalyst, in the catalyst product lies between ≧0 m²/g and ≦1000 m²/g, preferably between ≧20 m²/g and ≦800 m²/g, more preferred between 24 50 m²/g and ≦600 m²/g, and also most preferred between ≧90 m²/g and ≦450 m²/g.

A preferred embodiment of a catalyst according to the present invention is characterized in that the micropore volume of the clay mineral and/or zeolite, which forms the basis of the catalyst, in the catalyst product lies between ≧0 cm³/g and ≦0.4 cm³/g, preferably between ≧0.02 cm³/g and ≦0.25 cm³/g, more preferred between ≧0.04 cm³/g and ≦0.2 cm³/g, and also most preferred between ≧0.05 cm³/g and ≦0.18 cm³/g.

A preferred embodiment of a catalyst according to the present invention is characterized in that the mesopore volume of the clay mineral and/or zeolite, which forms the basis of the catalyst, in the catalyst product lies between ≧0 cm³/g and ≦1.0 cm³/g, preferably between ≧0.01 cm³/g and ≦0.80 cm ³/g, more preferred between ≧0.015 cm³/g and ≦0.60 cm³/g, and also most preferred between ≧0.020 cm³/g and ≦0.51 cm³/g.

A preferred embodiment of a catalyst according to the present invention is characterized in that the interlayer spacing between two layers of the clay mineral and/or zeolite-type mineral, which forms the basis of the catalyst, in the catalyst product lies between ≧0 nm and ≦5 nm, preferably between ≧0.5 nm and ≦3 nm, more preferred between ≧1.0 nm and ≦2.5 nm, and also most preferred between ≧1.4 nm and ≦2.1 nm.

A preferred embodiment of a catalyst according to the present invention is characterized in that the catalyst has a thermal loading in steady state of ≧300° C., preferably of ≧400° C., more preferred of ≧500° C., further preferred of ≧600° C., and also most preferred of ≧650° C. and ≦700° C.

The binder required for the monolith formation can likewise be produced on the basis of materials already described, wherein doping with the active element is omitted here. Therefore, full extrudates comprising a clay mineral/zeolite composite as catalyst and/or adsorbent are also possible. If the use of metal foils as substrate is desired, the active material can also be applied using a washcoat (coating) technology. The range of modification possibilities and/or production processes is not exhausted with this; plasma-assisted processes for coating or CVD (chemical vapour deposition), impregnation, wet precipitation and further methods frequently used for catalyst preparation can also be successfully applied.

On the one hand, it is possible to directly use naturally occurring minerals (zeolites and clay minerals) according to the invention, and on the other hand synthetically produced aluminosilicates with specified structure can be used for this purpose. Their production can generally be most inexpensive as a result of low synthesis temperatures (<100° C., no autoclave technique), short synthesis times and also through the saving or dispensing with expensive, organic template molecules (mostly alkyl ammonium salts such as TPABr/TPAOH) for the production. The advantages of natural minerals are fully realized in particular in the case of clay minerals, since a synthesis and/or purification process in preparation for the delamination, pillaring/ion exchange is very time-consuming and costly.

The method according to the invention principally provides the following advantages:
clear reduction in NOx cold start emissions, since NOx is principally removed by processing instead of reduction from the exhaust gas. An effective reduction only occurs when the temperature increases.
The periodic regeneration of a NOₓ trap otherwise known from the prior art is omitted. In particular, the greasing times to be adhered to separately are omitted.
A fuel saving of more than 5%-7% on average can be achieved through the method, since the engine can be operated with a λ of 1.1 (i.e. with excess air), in particular during start-up of the engine and in a very broad performance range.
The NOₓ, emissions already drop in the warm-up phase, compared to engines according to the prior art, and are reduced (decreased) by 52% at least on average.
The sulphur contents of the fuel and/or the engine oils are only of secondary importance for the reduction performance and/or the absorption processes, so that some considerable local differences in the fuel qualities cannot have a lasting harmful effect on the catalyst unit.

The above-mentioned and claimed structural parts described in the embodiments and to be used according to the invention are not subject to any special exceptional conditions with respect to their size, shape, material selection and technical design, and therefore the selection criteria known in the field of application can be applied without restriction.

### BRIEF DESCRIPTION OF THE DRAWINGS

The present invention will hereinafter be described in conjunction with the following drawing figures, wherein like numerals denote like elements, and:

FIG. 1 shows a highly schematic cross-section through a reactor with a catalyst with a serial arrangement of NOₓ-absorbing and NOₓ-reducing material.

FIG. 2 shows a highly schematic cross-section through a reactor with a catalyst with an alternating arrangement of NOₓ-absorbing and NOₓ-reducing material.

FIG. 3 shows a highly schematic cross-section through a reactor with a catalyst with a (homogeneous) distribution of NOₓ-absorbing and NOₓ-reducing material within the coating or directly in the catalyst (in the case of full extrudates).

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

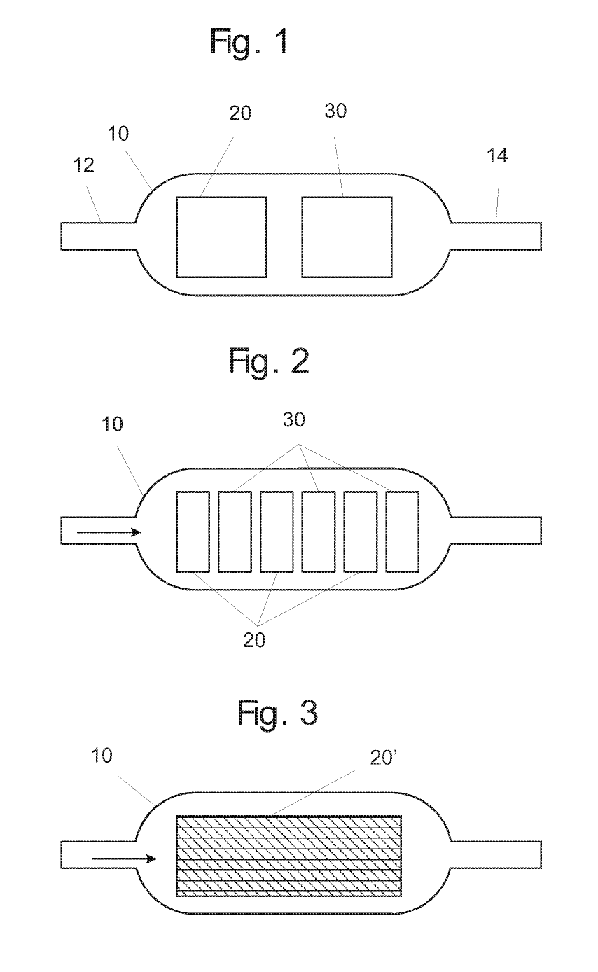

FIG. 1 shows a—highly schematic—cross-section through a reactor 10 with a catalyst with a serial arrangement of NOₓ-absorbing and NOₓ-reducing material 20 and 30 respectively. The exhaust gas enters the reactor 10 through the inlet 12 approximately in the direction of the arrow, and firstly strikes against a material 20, which contains a NOₓ-absorbing material. Thus, an absorption of NOₓ from the gas phase firstly occurs. This applies particularly after a cold engine start, since in this case the exhaust gas temperature is too low for the reduction of the nitrogen oxides using conventional methods and the NOₓ concentration is particularly high. The incorporated quantity of NOₓ-absorbing material is matched to the expected raw emission of the engine and also the temperature level of the exhaust gas. In this case, the NOₓ-absorbing material can be incorporated into the reactor 10 in all the ways known from the prior art, in particular in the form of pellets, as a washcoat or on a carrier material (metals and/or ceramics are preferred in this case).

A material 30 containing or completely composed of NOₓ-reducing material is then arranged in turn in the direction of flow of the exhaust gas. All shaping processes known from the prior art can also be considered here, in particular pellets, washcoat or carrier materials (metals and/or ceramics are preferred in this case), and also monolithic bodies (e.g. full extrudates).

As the engine temperature rises during travel and thus the exhaust gas temperature rises with a time shift, NOₓ is slowly desorbed from the material 20, which contains a NOₓ-absorbing material, and now passes in increased concentration to the material 30, which contains a NOₓ-reducing material. Here, a reduction of the NOₓ is then catalysed with reducing agents present in the exhaust gas such as hydrocarbons, ammonia or CO/H₂. Because of the high selectivity of the NOₓ-reducing material and/or the NOₓ-absorbing material, the nitrogen oxides are generally converted at adequate conversion rates, preferably without any additional injection of fuel or engine-controlled after-injection. However, additional devices such as evaporators for performance-controlled dosage of a suitable reducing agent and/or control devices for additional engine measures can be provided for special travel conditions.

FIG. 2 shows a—highly schematic—cross-section through a reactor 10 with a catalyst with an alternating arrangement of NOₓ-absorbing and NOₓ-reducing material 20 and 30 respectively. Thus, in this reactor 10 several absorption and reduction steps as described above occur in succession. The layers and the quantities of NOₓ-absorbing and -reducing material are preferably matched to the engine and exhaust gas profile, and therefore do not need to be identical to one another. This applies in particular when the catalytic activity of the NOₓ-reducing material 30 decreases as a result of the decreasing temperature of the exhaust gas along the reactor. In this case, individual sections or layers 30 can then be configured wider and/or larger, or the concentration of NOₓ-reducing material 30 can be increased. Conversely, the layers of NOₓ-absorbing material 20 can also be configured so that, for example, a larger quantity of NOₓ-reducing material 20 is firstly present in order to firstly achieve as complete an absorption of the NOx as possible. In this way, it is also assured that penetrations of NOx (because of too high a space velocity, i.e. too low a retention time) on the reduction catalyst cannot escape untreated into the atmosphere, but can be detoxified in subsequent reaction compartments.

FIG. 3 shows a—highly schematic—cross-section through a reactor 10 with a catalyst 20′ with a homogeneous distribution of NOₓ-absorbing and NOₓ-reducing material in the catalyst. The catalyst 20′ is preferably produced via a pelleting process. This catalyst 20′ allows a constantly high NOₓ concentration to occur in the entire reactor bed in the desorption phase. This in turn has a favourable effect on the conversion rate and therefore on the efficiency of the entire method, since otherwise concentration gradients, which can in turn have a negative influence on the conversion rate (known dependence of the reaction speed on the reactant concentrations, kinetics), must be expected in the flow direction from the inlet 12 to the outlet 14.

A method such as described above and/or a catalyst suitable for this according to the present invention can be used in all motor vehicles and motor vehicle types. In this case, it is of no consequence whether these are automobiles or lorries, for example, or whether Of to-cycle, diesel or CNG engines are used. Engines equipped with the most modern combustion processes such as HCCI (homogeneous charge compression ignition) or CAI (controlled auto ignition) can also benefit from this method.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for reducing NOₓ in the exhaust gas flow of a motor vehicle by means of a catalyst, the method comprising the steps of:
subjecting the exhaust gas flow to a NOₓ-absorbing material present in the catalyst; and
subjecting the exhaust gas flow to a NOₓ-reducing material additionally present in the catalyst;
wherein the NOₓ-reducing material is NOₓ-absorbent at temperatures of ≦500° C.2.

2. The method according to claim 1, wherein the NOₓ-reducing material is NOₓ-absorbent at temperatures of ≦400° C.3.

3. The method according to claim 1, wherein the NOₓ-absorbing material is a NOₓ-absorbent at temperatures of ≦500° C.

4. The method according to claim 1, wherein the NOₓ-absorbing material is arranged before the NOₓ-reducing material in the exhaust gas flow.

5. The method according to claim 1, wherein at least one section containing the NOₓ-absorbing material as well as at least one section containing the NOₓ-reducing material are respectively arranged alternately one after the other in the exhaust gas flow.

6. The method according to claim 1, wherein the NOₓ-absorbing material as well as the NOₓ-reducing material are distributed approximately homogeneously in the catalyst.

7. The method according to claim 1, wherein the NOₓ-absorbing material comprises a material selected from the group consisting of natural, synthetic, ion-exchanging, non-ion-exchanging, modified, non-modified, “pillared”, and non-“pillared” clay materials, sepiolites, attapulgites, natural, synthetic, ion-exchanging, non-ion-exchanging, modified, and non-modified zeolites, Cu, Ba, K, Sr, and Ag-laden, Al, Si, and Ti-“pillared” montmorillonites, hectorites doped with Fe, In, Mn, La, Ce or Cu as well as mixtures thereof, and Cu, Fe, Ag, Ce-laden clinoptilolites as well as mixtures thereof.

8. The method according to claim 1, wherein the NOₓ-reducing material comprises a material selected from the group consisting of natural, synthetic, ion-exchanging, non-ion-exchanging, modified, non-modified, “pillared”, and non-“pillared” clay materials, sepiolites, attapulgites, natural, synthetic, ion-exchanging, non-ion-exchanging, modified, and non-modified zeolites, Cu, Ba, K, Sr, or Ag-laden, as well as Al, Si-, or Ti-“pillared” montmorillonites, hectorites doped with Fe, In, Mn, La, Ce or Cu as well as mixtures thereof, and Cu, Fe, Ce, and Ag-laden clinoptilolites as well as mixtures thereof.

9. Catalyst suitable for performing the method according to claim 1.

10. Motor vehicle including a catalyst and/or a method according to claim 1.

11. The method according to claim 2, wherein the NOₓ-reducing material is NOₓ-absorbent at temperatures of ≦300° C.

12. The method according to claim 11, wherein the NOₓ-reducing material is NOₓ-absorbent at temperatures of ≦200° C.

13. The method according to claim 12, wherein the NOₓ-reducing material is NOₓ-absorbent at temperatures of ≦150° C. and ≧20° C.

14. The method of claim 3, wherein the NOₓ-absorbing material is NOₓ-absorbent at temperatures of ≦400° C.

15. The method of claim 14, wherein the NOₓ-absorbing material is NOₓ-absorbent at temperatures of ≦300° C.

16. The method of claim 15, wherein the NOₓ-absorbing material is NOₓ-absorbent at temperatures of ≦200° C.

17. The method of claim 16, wherein the NOₓ-absorbing material is NOₓ-absorbent at temperatures of ≦150° C. and ≧20° C.
